(19) United States
(12) Patent Application Publication
(10) Pub. No.: US 2002/0054089 A1
(43) Pub. Date: May 9, 2002

(54) Method of selecting content for a user

(76) Inventors: Donald L. Nicholas, Wayland, MA (US); Louis N. Weiss, New York, NY (US); David H. Starr, New York, NY (US); Gail Odeneal, Wayland, MA (US); Roxanne M. O'Connell, Franklin, MA (US)

Correspondence Address: Valarie Rosen, Ph.D., Choate, Hall & Stewart, 53 State Street, Exchange Place, Boston, MA, 02109, US

(21) Appl. No.: 09/808,672

(22) Filed: Mar. 14, 2001

Related U.S. Application Data
(60) Provisional application No. 60/189,230, filed on Mar. 14, 2000.

(51) Int. Cl. G09G 5/00

(52) U.S. Cl. 345/745; 345/738; 345/736

(57) ABSTRACT

An on-line server system that selects media information for a user according to the user's preferences. The server system comprises a content subsystem, a profile subsystem, and an administration subsystem. The content subsystem collects, stores, and updates media information. The profile subsystem creates a user profile. The administration subsystem is adapted and constructed to match the user profile with media information from the content subsystem and periodically generate an electronic newsletter.

This application claims the benefit of U.S. Provisional Application No. 60/189,230 filed Mar. 14, 2000, the entire contents of which are incorporated herein by reference.

### FIELD OF THE INVENTION

This invention pertains to a method of selecting content for a customer from a database corresponding to preference information collected from the customer.

### BACKGROUND OF THE INVENTION

One of the benefits of the Internet for users is that its content can generally be accessed for free. Unlike a newspaper or a cable television, the vast array of information on the worldwide web does not require payment of a subscription fee or a monthly bill. Once a small fee is paid to the user's Internet service provider (ISP), a wide variety of content ranging from recipes to news to fiction is only a mouse click away. However, nothing is free. The user's access to the web and various web pages are paid for, not by the user, but by advertising. Various advertisers use advertisements on webpages or the webpages themselves to entice customers to learn about and hopefully purchase a product. For example, many companies maintain websites which describe their products and provide a mechanism for a customer to place an order. However, whether or not a company has a webpage, it may purchase advertising space on others' websites to increase visibility and generate sales. These advertisements may direct a customer to a business's home webpage or may simply display information encouraging a customer to physically visit a particular store or website.

In addition, there are websites which exist solely to provide content to visitors. Many news organizations maintain websites which contain excerpts or entire articles selected from their publications, and may also contain ads. These websites provide visibility, increase goodwill for the website provider, serve as a source of advertising revenue, and may even generate some business for the company's physical product. In addition, these websites may provide content that is specifically aimed at the Internet visitor which may not even be present in the physical product.

The increased sophistication of programming languages has made it possible to gear advertisements on a webpage to the individual visitor. A website may ask a first time visitor to become a member or to register a profile. The visitor is reassured that registration does not incur a fee and merely enables the website to tailor its content to the viewer's interests. Once the visitor has provided the profile information, the website can track the visitor's behavior as he or she moves through the various webpages connected to the site. This information is digested and used to create a profile of the visitor which indicates which advertisements and products would be most likely to interest the visitor. The advertiser can then produce an individually tailored display each time a registered visitor returns to the website rather than providing a single advertisement designed to appeal to a large cross-section of Internet users. By tailoring the ads to individual visitors, the advertisers increase the possibility that the visitor may respond by clicking on an ad to visit the advertiser's site or by simply visiting the advertiser's physical place of business. Methods of generating a viewer profile are well known in the art and are described, for example, in U.S. Pat. Nos. 5,991,735 and 6,009,410, the entire contents of both of which are incorporated herein by reference.

It is also known that the Internet can be used to provide a user with a preview of a product and then allow the user to purchase the entire product. U.S. Pat. No. 5,963,916, the contents of which are incorporated herein by reference, describes an Internet method for providing a sample of a piece of music to an Internet user while providing the user the opportunity to purchase the entire song or a collection of songs. Indeed, this technique is not only confined to the Internet, it is practiced every day by visitors to bookstores who read the plot summaries and author biographies on the dust jacket before deciding to buy a particular book.

### SUMMARY OF THE INVENTION

In one aspect, the invention is an on-line server system that selects media information for a user according to the user's preferences. The system comprises a content subsystem that stores and updates media information, a profile subsystem that creates a user profile and an administration subsystem that matches the user profile to media information from the content subsystem and periodically generates an electronic newsletter. The content subsystem may comprise a content database that collects, stores, and updates summaries of media information. The server system may maintain data communication between the administration, profile, and content subsystems. The administration subsystem may select media information according to the user's profile.

In one embodiment, the profile subsystem collects profile information from the user. The profile information may include a record of the user's past interactions with the server, a record of the user's current interaction with the server, preferences indicated by the user, or any combination of the above. The profile subsystem may update the user's profile based upon the user's interaction with the server or when a user chooses to change his or her stated preferences. The profile subsystem may create a first user profile including preferences indicated by the user and a second user profile comprising a record of the user's past interactions with the server.

The media information may comprise books, magazines, magazine articles, trade journals, music and film videos, film, radio, music, periodicals, sections of the above, or any combination thereof. The electronic newsletter may comprise media information, summaries of media information, advertisements, photographs, videos, visual art objects, audio objects, color, or any combination of the above. The administration subsystem may select media information to match with one or more advertisements, photographs, videos, visual art objects, audio object, color, and any combination of the above. The electronic newsletter may allow the user to purchase or subscribe to a source of the media information. The electronic newsletter may also allow the user to forward media information or the electronic newsletter to an Internet user.

The content subsystem may associate the summary of media information with a numerical value. For example, the content subsystem may associate the summary with a first numerical score as a function of a source of the summary, a price of the source, a distribution of the source, the popularity of the source, or any combination of the above. The profile subsystem may associate the user profile with a second numerical score as a function of a number of times a summary is selected by the user, a sequence in which the summary is selected or viewed with respect to other summaries provided to the user by the server, the sequence in which the summary is selected or viewed with respect to other summaries provided to other users, a number of media the user has purchased, a route in which the user obtained access to the server, or any combination of the above. The administration subsystem may generate the electronic newsletter by matching the user's profile with the first numerical score, the second numerical score, or both.

In another embodiment, the administration subsystem generates a first message for a plurality of users comprising a first special offer. The first special offer is generated by matching the users' profiles with the first numerical score. The message may be posted to the users via e-mail or via an Internet site. The message may allow the user to accept the special offer by subscribing to a source of media information. The administration subsystem may generate a second message for a second plurality of users with a second special offer. The second plurality of users does not include any members of the first plurality of users.

In another aspect, the invention is a method of selecting content for a website user. The method comprises comparing a user profile with a content score for each of a plurality of content summaries and identifying at least one content summary having a content score most closely related to the user profile. The content summary comprises a freestanding idea representative of a source of the content, and the method further comprises providing at least one content summary to the user in an electronic newsletter. The method may further comprise compiling the user profile from, for example, user information derived from observation of the user, information provided by the user, or both. The user information may further comprise a record of the user's past and current interaction with the server, preferences indicated by the user, or both. The method may further comprise compiling the content score as a function of a topic of the content summary, an age of the summary, a price of the source, a sales volume of the source, the source of the content, a frequency with which content summaries from the source are used, a profitability of the source, or any combination of these. The method may further comprise providing a plurality of rules for performing the steps of comparing and identifying. The step of providing summaries may comprise providing an option for the user to perform an action such as requesting an additional content summary, forwarding a content summary to an Internet user, purchasing or subscribing to the source of the content, or any combination of these. If the user requests an additional content summary, the user profile may be updated. The method may further comprise presenting an additional element to the user including an advertisement for the source of the content, a picture of the source of the content, a visual art object, an audio object, a color or any combination of the above.

The method may further comprise generating a first message for a plurality of users comprising a first special offer. The special offer is generated by matching the users' profiles with the content score. The first message may be posted to the users via email or via an Internet site. The method may further include allowing the user to accept the special offer by subscribing to the source of the content. The method may further comprise generating a second message for a second plurality of users comprising a second special offer.

### BRIEF DESCRIPTION OF THE DRAWING

The invention is described with reference to the several figures of the drawing, in which,

FIG. 1 is a schematic of a server system according to the invention;

FIG. 2 is a picture of an exemplary newsletter created according to the methods of the invention;

FIG. 3 is a flow chart depicting a new user's progress through a website supported by the server system;

FIG. 4 is a picture of an introductory webpage created for a new visitor to the website supported by the server system;

FIG. 5 is a picture of a webpage which depicts a selection of sample newsletters created according to the methods of the invention;

FIG. 6 is a picture of a webpage depicting the magazine shop showing a selection of categories offered to users of the server system;

FIG. 7 is a picture of a website depicting a sample selection of media offered to a user of the server system; and

FIG. 8 is a picture of a webpage depicting an advertisement/solicitation page created by the server system.

### DETAILED DESCRIPTION

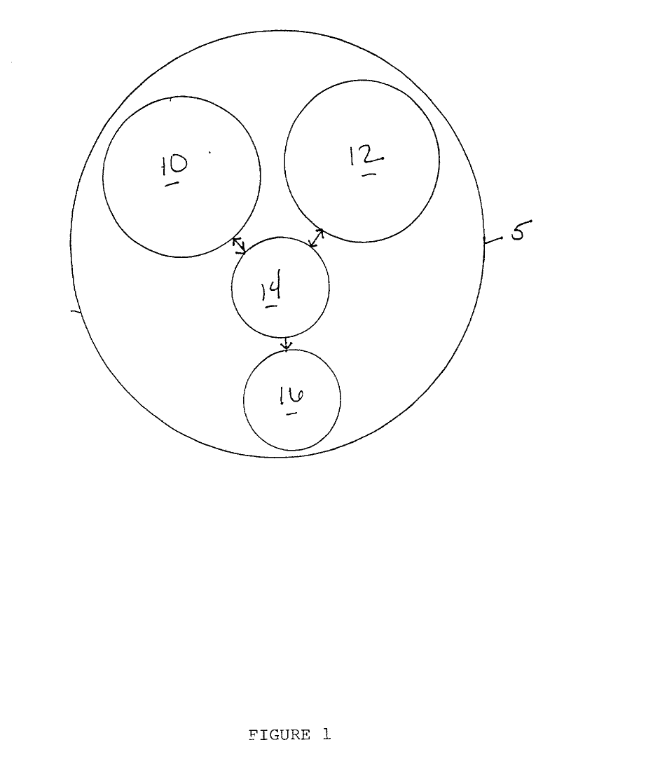

FIG. 1 depicts a schematic of a media-customer matching system 5 according to the invention. The matching system 5 combines a multisource electronic sampling subsystem 10 with a dynamic member profiling system 12 to produce a periodic newsletter 16 according to rules 14 which are imbedded in the matching system 5. The specification focuses its discussion on a server system. However, some of the methods of the invention may not necessarily be performed on the server system itself. Therefore, it will be apparent to one skilled in the art that the server system may be described as an Internet system implemented using servers, web browsers and other components.

The multisource electronic sampling (MSES) subsystem 10 is a content database comprising excerpted content from a variety of media sources, for example, magazines. In an exemplary embodiment described below, the media are magazines; however, the invention is meant to encompass any media, including but not limited to books, newspapers, trade journals, film, radio, videotape (e.g., lectures, concerts, movies, performances, children's videos, animation, music, etc.) or music, including both analog and digitized music. Portions of these media, e.g., book chapters, magazine articles, or movements of a symphony, may also be utilized for the invention. For example, an operator may create a 100-200 word summary of at least one article from each magazine chosen for the database, and store the summaries in the database. Alternatively, the selected media may be simply excerpted, e.g., the chorus of a song may be excerpted and placed in the database.

In a preferred embodiment, the summary or excerpt created by the operator represents a freestanding idea. However, while the summary, or tip, contains a single idea, it represents a class of ideas which may be included in the corresponding medium or portion. For example, a tip for a magazine article describing ten methods of controlling weight through diet may provide a brief summary of one of the ten methods. Each tip is provided a content identifier including a broad subject area, or channel, a topic categorized under the channel, and a subtopic grouped under the topic area. For example, the weight loss tip described above may be assigned the topic “Nutritional Weight Loss,” a subtopic under the topic “Weight Loss.” The channel for “Weight Loss” is “Health,” which may also include other topics such as medical care, psychology, and physical fitness. In another example, exemplary topics under the channel “Travel” may include “Europe,” “North America,” “Cruises,” and “Air Travel.” Under “Europe,” exemplary subtopics may include individual countries, e.g., France, Belgium, and Germany. The content identifier is one component of a tag which also includes the magazine name and issue date, and a given tip may be assigned a plurality of tags. For example, a tip for an article describing weight loss through a combination of drugs and diet modification may be tagged with two topics, “Pharmaceutical Weight Loss” and “Nutritional Weight Loss.” Each tip is also assigned a score by the MSES subsystem 10. The score may be based on such factors as the price and sales volume (locally, regionally, nationally, or through the website) of the originating magazine, a fraction of the purchase price that is remitted to a publisher, and a date of the issue of the magazine from which the article was taken. Thus, a tip from a relatively expensive magazine or one for which the remit to the publisher is a relatively low proportion of the purchase price may have a higher score. Conversely, the score of a tip will decrease over time as the tip becomes older and older. After a specific period of time, for example, twelve months, the tip may be purged from the MSES subsystem 10. The score will also be adjusted based on the utilization of the tip by the matching system 5 and purchases of the originating magazine by customers, both of which are discussed below. Alternatively, information concerning the various factors may be stored in a database entry associated with the tip.

In an exemplary embodiment, the MSES subsystem includes 20 channels, for example, Money, Travel, Health, etc. Each of these channels may have a number of topics, e.g. 10, each of which in turn also have a specific number, e.g. 10, of subtopics. The number and content of the topics, subtopics, and channels is not meant to be limiting, and they may be modified, added, or subtracted depending on the content of the tips in the MSES subsystem 10 and the media information available for creating the tips.

The second component of the matching system 5 is the dynamic member profile (DMP) subsystem 12. The DMP subsystem 12 contains all of the information about the individual customers. The DMP subsystem 12 creates a profile for each customer in each subtopic. This profile may include both an internal and an external component, which may be combined to create a total profile.

The internal score is based on both the stated and observed preferences of the customer. The stated preference information is collected from the customer both in an initial profile collection when the customer becomes a registered member of a site and over time. The initial stated preferences may include the subtopics in which the customer indicates an interest. Other stated preferences may include the magazines to which the customer subscribes, free time activities such as hobbies, or community organizations, sports, or profession. Over time, information may be also collected on the customer's Internet usage and other day-to-day activities. The stated preference information is directly provided by the customer in response to questions presented by the website.

The observed preferences are based on the customer's behavior while logged in to the website or while reading/interacting with the alert. For example, the system may record a history of which tips the customer does or does not read and which magazines the customer eventually buys as a result of reading a tip. The system may also update the profile based on whether the customer forwards a particular tip to another Internet user (and the content of the forwarded tip) or discontinues a particular magazine subscription.

The data used to create the profile may be assigned a numeric value and combined to create a total profile score. For example, if a customer indicates an interest in the topic weight loss, he or she may be assigned a 5 for all the subtopics under that topic. If the customer further indicates an interest in nutritional or pharmaceutical weight loss, a higher score may be recorded for the customer for these subtopics. The score is adjusted over time based on how often the customer reads tips that are categorized in those topics. In the meantime, a customer's interest in nutritional or pharmaceutical weight loss may create a score for that customer in some of the topics under the health channel. The DMP also includes information on which tips the customer has already read.

The external profile is partially based on how the customer arrived at the website. For example, if a customer clicked a banner ad including a link to the website, a score may be created based on demographic information collected about users of the webpage where the ad was located. For example, it may be known that viewers of a particular webpage are interested in parenting. A customer who comes to the website after clicking a banner ad in that particular webpage will automatically be given a score based on a presumed interest in parenting. In addition, the external profile includes information about the appearance of the banner ad. Thus, the external code includes a source (banner location) and creative (type of banner) component. Of course, a user may happen to stumble upon the website without having encountered advertising for the site in another location. Even in this case, the new customer can be asked how he or she first became aware of the website and provide information which may contribute to an external profile. In addition, there are Internet services that collect information about Internet users based on their activity at a variety of websites. See, e.g., U.S. Pat. No. 5,948,061, incorporated herein by reference. This information can be purchased from these services and used to generate the external profile. The external and internal profiles may each include information on the types of banner logos that the customer has clicked on. For example, a particular customer may have selected more advertisements that were created with pastel color banners than with primary colored banners. Alternatively, a customer may have responded to a particular type of photograph or art present in a given ad.

The internal and external scores may be as precise as needed to provide individualize content for each customer. For example, a score may be given between 1 and 10, 1 and 100, 1 and 1000, or between 1 and any other number. In addition, the precision of the score may be changed over time simply by adding decimal places to the score. For example, the precision of a 1 to 10 scale may be increased by a factor of ten by using fractional scores (1.1, 1.2, 1.3, etc.) instead of integral scores (1, 2, 3, etc.). It will be apparent to one skilled in the art that the scoring methods disclosed in the present application are not the only scoring methods available.

Alternative qualitative and quantitative methods of matching the user's profile to the media content are also contemplated. For example, it is contemplated that quite a number of demographic, psychographic and behavioral criteria may be used to target users and that any scoring system, including, but not limited to, any numerical scoring system, disclosed in the application is not limited to that particular scoring system. For example, artificial intelligence techniques may also be exploited to evaluate the content of the sampled media and the behavior and preferences of the users. In connection with such systems, it may be preferable to collect a complete history of customer interactions with the website, rather than simply maintaining one or more numerical scores which are modified by customer interactions. Collecting a complete history allows continuing development of algorithms for better understanding of customer behavior, and allows such algorithms to be implemented on the basis of historical data.

Both the stated and the observed preferences of a user may be modified during each interaction with the website, resulting in a constant, dynamic change in the customer's profile. The stated preferences change because the customer may be asked profiling questions each time there is an interaction with the website. The questions may be organized to focus on a customer's specific interests. For example, a customer may be asked to indicate a preference for individual or team sports. A question posed during a subsequent interaction may determine whether the customer prefers indoor or outdoor sports. The questions may become narrower and narrower until it is finally ascertained that the customer has an interest in team sports but really enjoys doubles ping-pong.

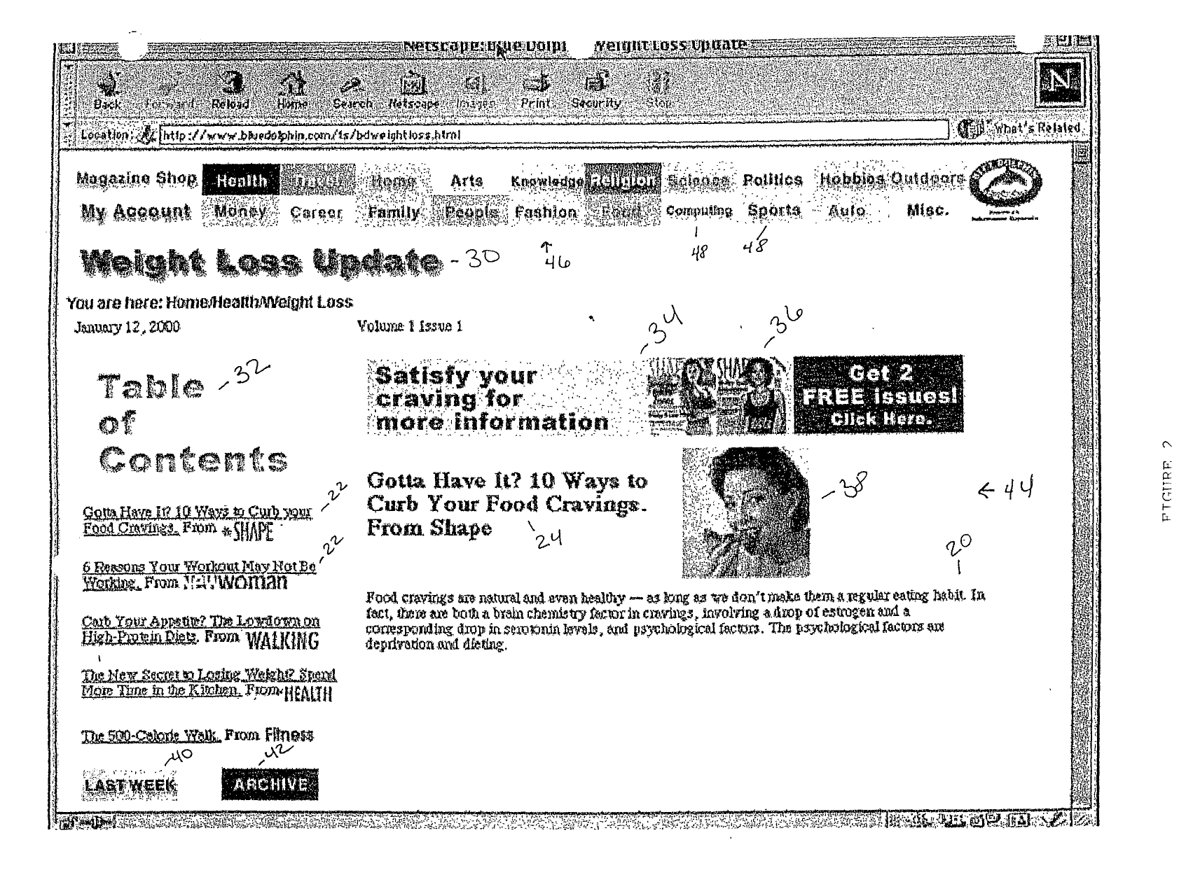

At specified intervals, for example, once a week, the media-customer matching subsystem 5 generates a newsletter 16 for each customer based on a set of rules 14 for combining the scores in the MSES subsystem 10 and the DMP subsystem 12. (An exemplary newsletter is shown in FIG. 2). For example, the user's profile may include the subtopics in which the customer has indicated an interest, and the rules may indicate that the newsletter should include a tip for each selected subtopic. A newsletter is generated for each topic for each customer who has indicated an interest therein. The MSES and DMP profiles are combined according to rules 14 to select specific tips for each customer receiving a newsletter 16. These tips may be prioritized; the highest-ranking tip 20 may be presented to the customer immediately upon receipt of the newsletter, while only teasers 22 for the other tips would be initially displayed. The teaser 22 for a tip may be the same as a headline 24 for the source article. Alternatively, the teaser 22 may be a phrase or sentence that more specifically describes the content of the tip itself or a general theme of the originating article. The newsletter is presented in the form of a webpage, although it may be sent to the customer via e-mail. In addition to tips, the newsletter may include other elements that may be partially determined by the customer's profile in the DMP subsystem 12. For example, the colors used for the shading of the various buttons (e.g., 40 and 42), banners, and other display elements (e.g., newsletter title 30 and header 32) may be determined by the customer's behavior in response to other banners of various colors. A banner ad 34 promoting the source magazine for the displayed tip 20 may use a base color and one or more magazine covers 36 determined by the DMP profile. Other art, for example, photographs of various people or logos (e.g., photograph 38), are also chosen based on the DMP profile. Thus, for each tip 20, a packet 44 comprising, for example, the tip 20, the corresponding teaser 22 and headline 24, any art 38, a banner ad 34 for the source magazine, and one or more magazine covers 36, is assembled for the customer. Most of these elements can be varied independently for different customers. For example, while a tip 20 is associated with a specific headline 24, the art 38 and magazine covers 36 may be varied for different customers receiving the same tips. The newsletter also includes links allowing the customer to read the remaining tips, forward a tip or the entire newsletter to a friend, elect to receive free trial issues of the source magazine, or browse past newsletters. In addition, the newsletter includes a menu 46 that allows the customer to browse among other newsletters by selecting other channels or among various subtopics. The menu 46 or a second menu 47 may also include buttons 48 allowing the customer to view account information or a selection of available magazines.

If the customer's e-mail is HTML-capable, then the customer can read the newsletter, including all the tips, in the e-mail message. However, if the customer's email is not HTML-capable, then the media-customer matching system 5 will generate an e-mail alert to the user including an invitation to read the customized newsletter on the website. The alert may contain an HTML link that enables the customer to immediately open a browser window and view the newsletter.

The various customers' behavior with respect to their newsletters may be incorporated into both the individual customers' DMP subsystem 12 profiles and the tips' scores in the MSES subsystem 10. For example, the sales of various magazines over time, the click through rates for various tips (from the tips to the magazine order page), the popularity of a given subtopic, and the age of the tip may all used to update the MSES subsystem 10.

Additionally, the DMP profile may be modified based on projected changes and interests. For example, if a particular customer reads several tips selected from Modern Bride, in two or three years, the customer's newsletter may include a tip selected from Parenting.

In addition, the newsletter may also contain a propositional tip. These are tips that do not necessarily provide the best match to the customer's DMP score, but instead were chosen to determine customer interest in a topic slightly outside the bounds of those indicated by the DMP profile.

In addition, the rules 14 are configured to recognize that a particular tip has been forwarded to a customer in a different newsletter, the customer may be provided with an alternative tip, albeit one which is not as closely aligned with the customer's DMP score. In addition to including buttons allowing a customer to subscribe to a magazine from which a tip was selected or to send a copy of a newsletter to another e-mail address, the newsletter also allows the customer to browse past newsletters. The DMP subsystem 12 keeps a record of the tips that have been sent to a particular customer and the composition, including the tip packets 44, of previous newsletters that have been forwarded to the customer. If the customer desires to read a newsletter which was generated before he or she joined the website, the media-customer matching system 5 will generate a newsletter based on the preferences of the customer or will display a generic newsletter based only on the tips' MSES scores.

Upon viewing a particular newsletter, a customer may decide to subscribe to a different newsletter either in addition to or instead of the current newsletter. If the customer decides to read the most recent newsletter for a previously unsubscribed topic, tips will be selected based on the customer's existing DMP profile for the topic of the new newsletter. For example, a customer who is over 70 years of age or subscribes to magazines that are geared towards mature audiences will be presented tips about golf and tennis in response to a request for the most recent outdoor sports newsletter instead of tips discussing more strenuous sports such as triathlon.

In general, the matching system 5 must create a balance between a number of opposing factors. For example, while it may be desirable to ask a large number of questions to fine tune a customer's internal score, if the website asks too many questions, the customer may simply stop answering them. In addition, while the rules 14 are designed to select tips that are closely matched to a customer's DMP profile, it is also desirable to determine whether the customer has interests that are not yet reflected in that profile by selecting tips whose MSES scores do not optimally match the customer's DMP profile. Additionally, customer may be interested in certain topics and may wish to see tips reflecting those interests; however, in addition to matching the reader's interests, the rules 14 may be configured to promote specific magazines that will generate the highest profits.

### EXAMPLES

### Example 1

### New Member

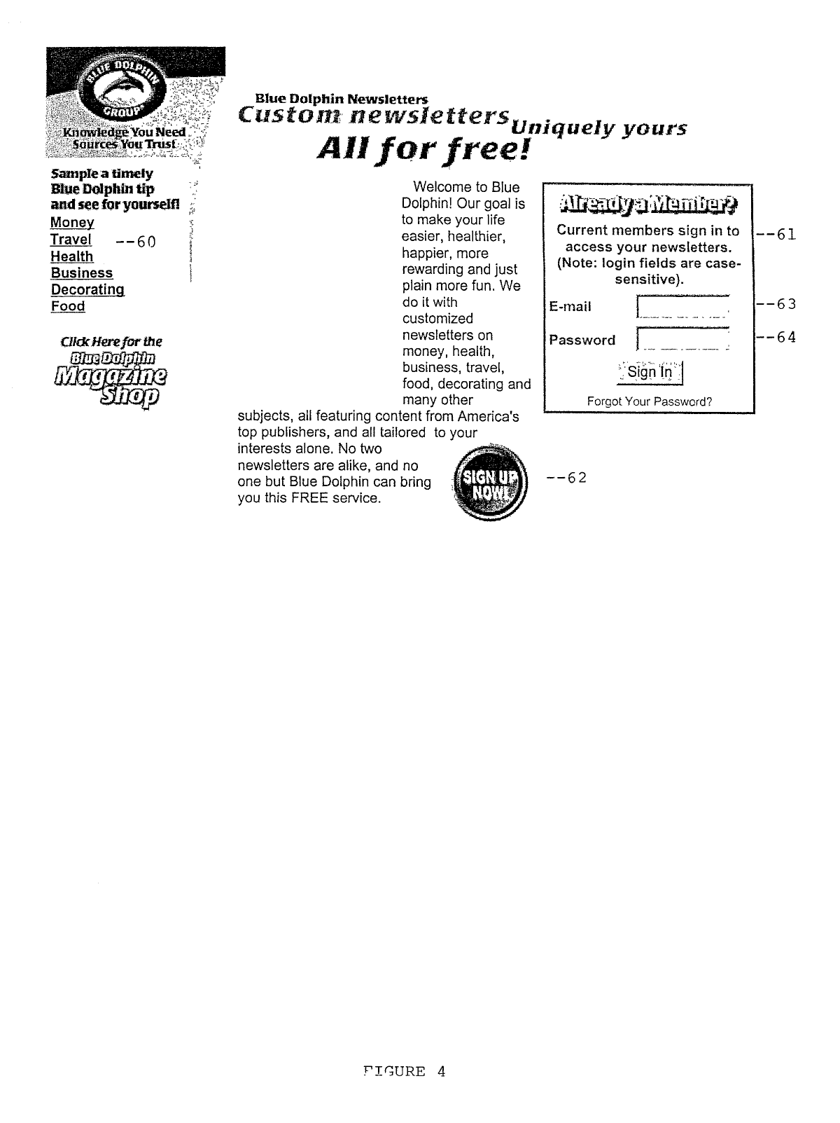

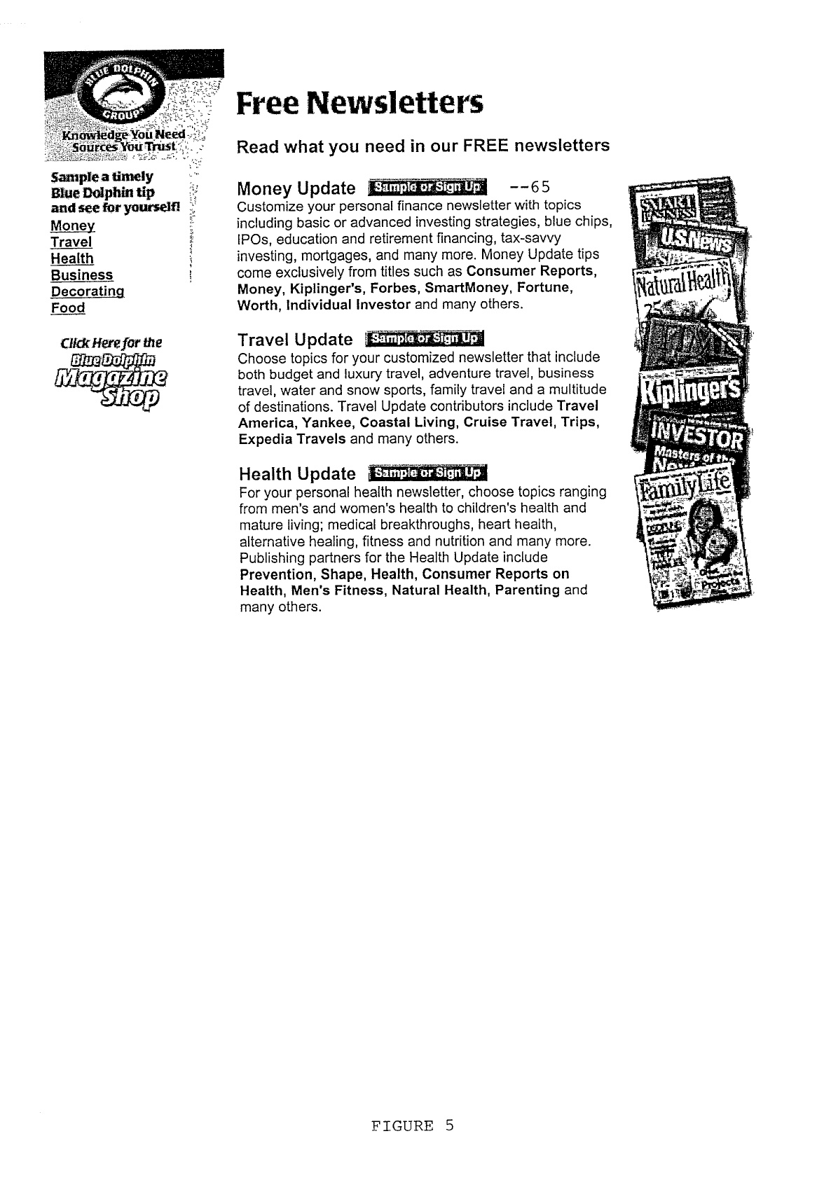

A prospective customer becomes a website member by visiting the website and registering. If the prospect is directed to the website from a banner ad in another website, then the prospective member may be directed to a specific channel webpage based on the content of the originating site. The channel webpage includes a list of all the newsletters categorized under that particular channel. Alternatively, if the prospect arrives at the website directly, a generic page will be shown, such as the one depicted in FIG. 4. The channel webpage and the generic webpage, in addition to all of the webpages within the site, include menu frames 60 allowing the prospect to browse among the different channels. The general webpage includes a prompt requesting that the prospect login 61 or register 62 to receive a newsletter. If the prospect is not already a website member, he or she is directed to an initial registration page. On the initial registration page, the prospect has an option to preview a newsletter. The preview page includes the current version of that particular newsletter and prompts the prospect to begin the registration process. Alternatively, the prospect may commence the registration process from the channel webpage. The registration process also includes an initial profile collection. First, the prospect is asked to choose a unique user name, for example, an email address 63, and is prompted to enter a different user name until one is chosen which is not already being used by another customer. The prospect also selects a password 64 and provides an e-mail address. If any of this information is not entered, the prospect may be returned to the profile form to correct the mistakes. However, the form may retain the prospect's previous correct entries and highlight the uncompleted required fields. The prospect may also optionally provide first and last name and zip code and may also indicate how he or she first became aware of the website. After entering the profile, the prospect, now a new member, is directed to a webpage at which additional newsletter subscriptions may be selected, as shown in FIG. 5. The newsletters may be selected by clicking on buttons 65 associated with each newsletter in a list of available newsletters, or by other controls such as checkboxes. When a user elects to receive a newsletter, he or she may be prompted to indicate a number of subtopics of interest.

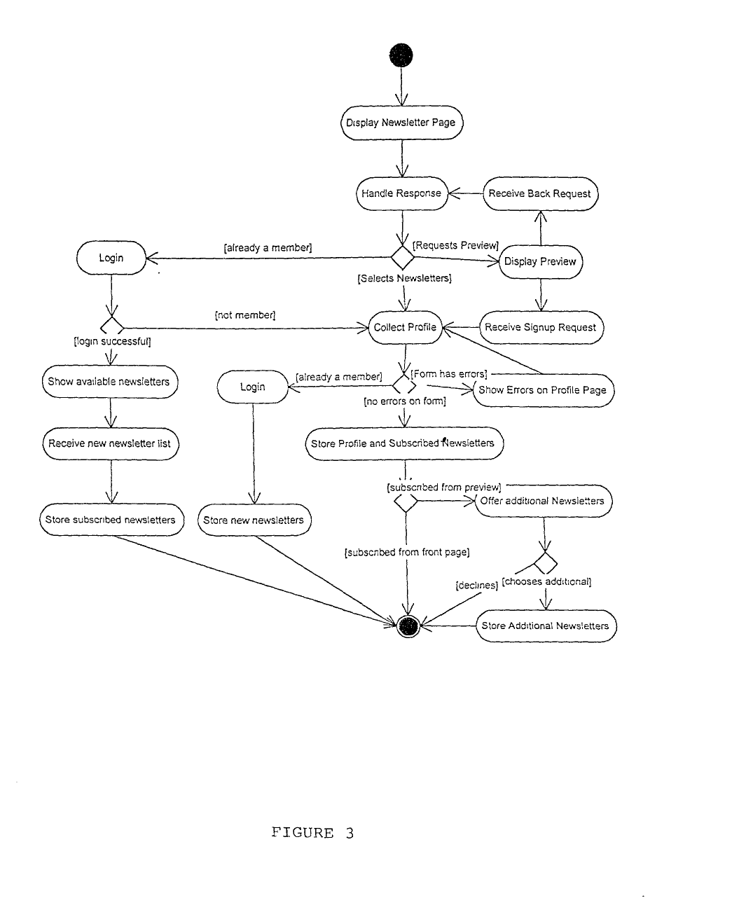

FIG. 3 is a flow chart describing a new customer's progress through the website in one embodiment of the invention. As profile and newsletter subscription information is collected, it is stored with the customer's account information in the DMP's subsystem 12. Of course, if a current website member enters the website, he or she may simply log in to subscribe or unsubscribe to newsletters and modify his or her profile information. A cookie may be placed so that the user will not need to log in when accessing the site from the same computer. The new customer enters billing information at the time the customer purchases a media. The billing information includes a mailing address and either a credit card number and expiration date or a debit card number. Because the customer's billing information is stored in the DMP's subsystem 12, it does not need to be reentered each time the customer decides to subscribe to a magazine. However, the customer may choose to have any given magazine sent to a different mailing address or billed in a different manner. In addition, the new customer may elect to have a cookie created which identifies the customer to the website at the beginning of each visit.

### Example 2

### Customer Receives Alert or Newsletter

Once a customer has subscribed to one or more newsletters, the matching system 5 generates each of these newsletters for the customer on a periodic basis. For example, the weight loss newsletter may be generated every Tuesday morning, while the computer programming newsletter may be generated on Friday afternoon. The newsletter is generated as described above and forwarded to the customer. If the customers e-mail is HTML-capable, then, when the customer reads the mail, the DMP subsystem will be informed that the newsletter was received and will record whether the customer reads specific tips, subscribes to magazines, or forwards a tip to another e-mail address. If the customer's e-mail is not HTML-capable, then the matching system 5 will generate an alert, which is mailed to the customer electronically. The customer may then login to the website to read the newsletter in a web browser. While the highest-ranking tip may be automatically displayed for the user, the customer may chose to read the other tips included in the newsletter by clicking on the teasers. Whether a customer reads the newsletter in an email program or a web browser, which tips were viewed and the time of viewing are recorded in the customer's profile. Because the newsletter includes the menus 46 and 47, the customer also has the option of viewing the current newsletter for other topics, subscribing to one or more of these newsletters, or subscribing to the magazines whose tips are included in the other newsletters.

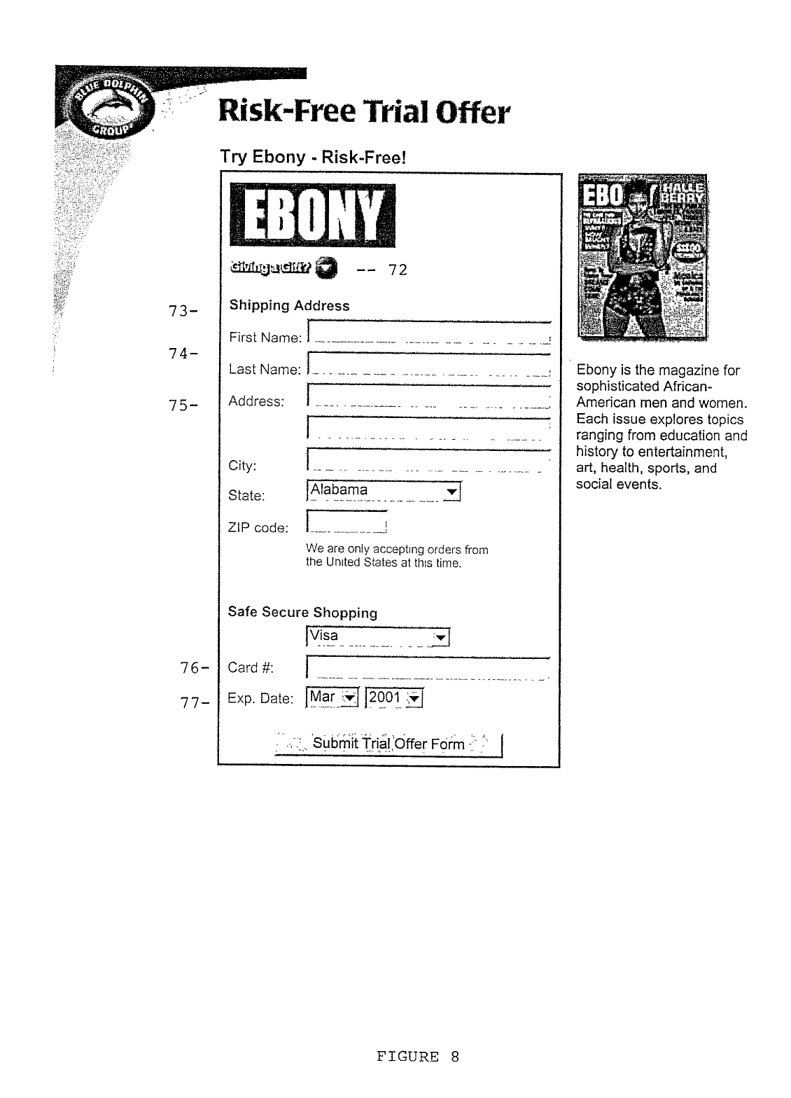

While the customer is viewing a tip, the website may display an option allowing the customer to subscribe to the originating magazine. For example, a promotion may be offered providing the customer with two free issues if a subscription is purchased. Alternatively, the customer may choose to purchase a gift subscription for a friend. The subscription webpage may be the same page accessed when browsing magazines within a magazine shop portion of the site, discussed below and depicted in FIG. 8.

Once a customer has viewed the new newsletter, he or she also may be given the option of viewing the current newsletter for the other topics and subscribing to one or more of these.

A customer who has logged into the website or received a newsletter via e-mail may also view and modify his or her account information. The account information includes current newsletter subscriptions, billing information, personal information, and the customer's initial profile information. If the customer has subscribed to a magazine through the website, then the account information also includes subscription information including the titles of any subscribed magazines, the expiration dates of the subscriptions, and various subscription options. For example, a magazine subscription can be renewed through the website, and the customer's account will be charged in the same manner as it was when the initial subscription was generated. Alternatively, if a customer is going to be on vacation or unable to receive mail for a given period of time, the customer may elect to hold delivery of subscribed magazines until a specified date. The customer may also view the status of subscriptions that have been purchased as gifts for friends and family and may renew those subscriptions as a further gift.

Additionally, the customer may access the list of magazines and subscribe to them directly without viewing the tips in the various newsletters. The customer may enter a website magazine shop which will prompt the customer for information on what type of magazine he or she is looking for. For example, the customer may indicate that the magazine purchase will be a gift for someone else or that the customer is looking for a magazine about outdoor cooking or needlepoint. Alternatively, the customer may be provided with a list of the top 10 best selling magazines or a list of magazines in a certain price range. In another embodiment, the website may get permission from various people to list the magazines to which they subscribe. In this case, the customer may choose a magazine based on what specific people, for example celebrities, are reading. Of course, the information volunteered by the customer in searching for a magazine to which to subscribe is used to update the score in the DMP subsystem 12.

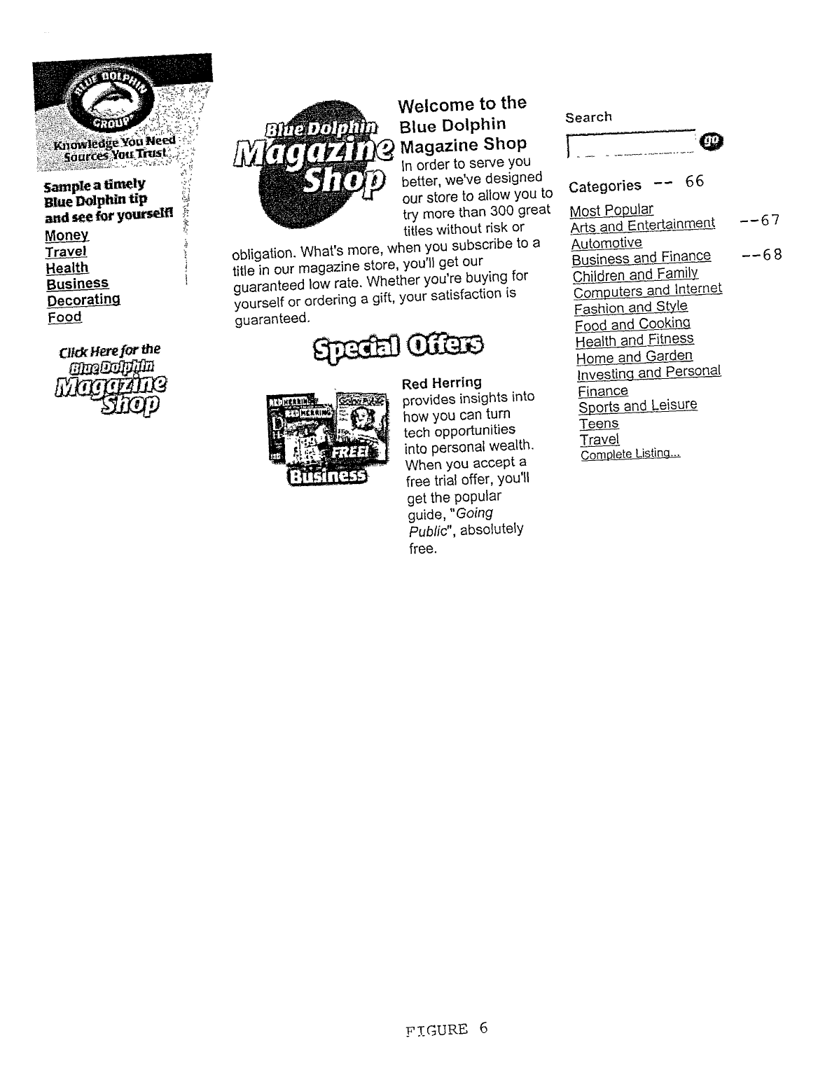

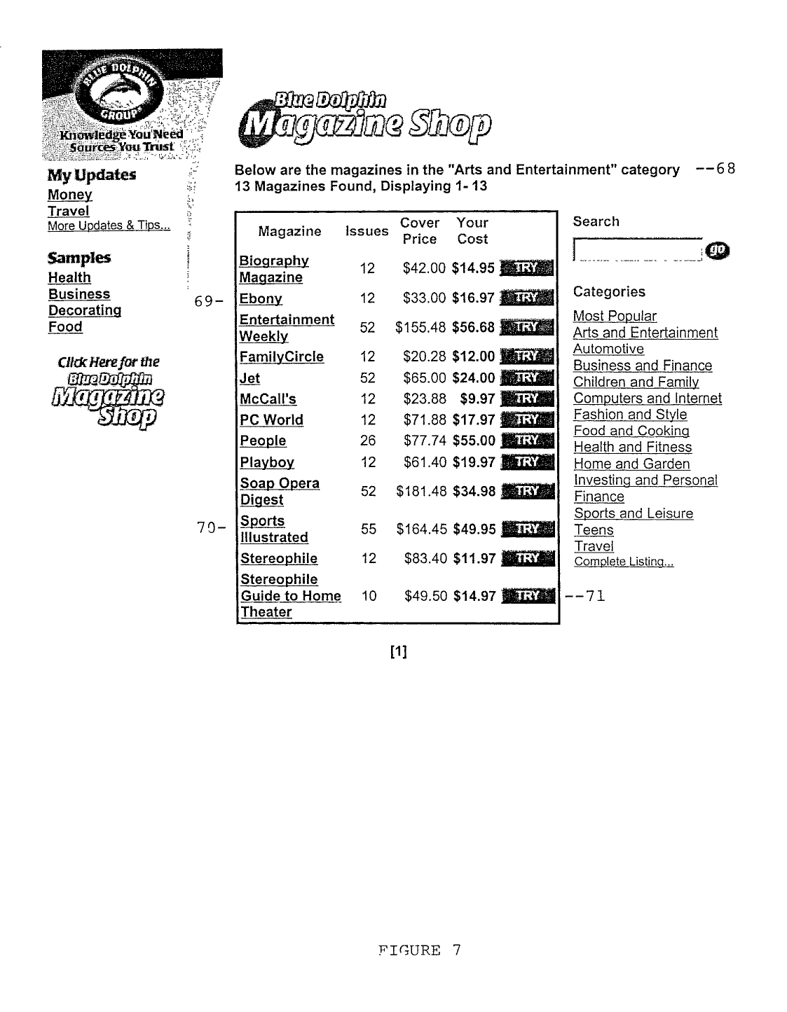

FIG. 6 depicts an exemplary webpage created by the server system for users of the system depicting a magazine shop. The magazine shop lists several categories 66 of media information, in this case, magazines, that may be selected by a user of the system, e.g., Arts and Entertainment 67 and Business and Finance 68. A user may select one of the categories of media, and will be forwarded to a webpage that lists the magazines currently available under the topic channel (FIG. 7). For example, if the user selects the Arts & Entertainment channel 67, the server system lists magazines currently available under the Arts and Entertainment channel (FIG. 7). In the example depicted in FIG. 7, the user is presented with a list of Arts & Entertainment magazines 68, including Ebony 69 and Sports Illustrated 70.

At this time, the user may select the “Try” icon 71 of one of the Arts and Entertainment magazines. For example, the user may click on the “Try” icon 71 adjacent to Ebony 69. The server system will then forward the user to a webpage (FIG. 8) that offers the user the option of purchasing a subscription of Ebony or purchasing a subscription of Ebony for another person as a gift 72. At this webpage, the user may be requested to provide shipping and payment information 73 including, but not limited to, name 74, address 75, credit card number 76, and credit card expiration date 77.

### Example 3

### Newsletter Forwarded to Another E-mail Address

As noted above, a customer may choose to forward the newsletter to a friend. Upon selecting this option, the website prompts the customer to enter the desired e-mail address and confirm the request by selecting a submit button. After the submission, the customer is directed to a webpage confirming that an e-mail notice was sent to the desired e-mail address. This email address receives a message similar to that originally received by the customer (the newsletter for HTML-enabled e-mail, an alert for non-HTML e-mail). However, either the alert or the newsletter, or both, will indicate that the customer originally sent the newsletter, and some of the text of the newsletter may be altered to invite the reader, now a prospective customer, to become a member. For example, the newsletter may contain links which enable the new prospect to register to receive the newsletter regularly. Alternatively, the current customer may send a particular tip to another e-mail address. Again, the new e-mail address will receive a message similar to that received by the customer originally; however, the new prospect will only be shown the one tip, not the other tips in the newsletter which was sent to the customer. As before, the new prospect may elect to subscribe to the newsletter and become a member. In addition, the DMP subsystem will record that a customer forwarded information to another e-mail address, what information was forwarded, and information about the destination e-mail address. Whether the new prospect chooses to receive the newsletter regularly or to become a member and receive other newsletters, he or she proceeds through the website as in Example 1.

### Example 4

### Specials

In addition to the newsletters regularly offered to the customer, special mailings may be provided inviting the customer to take advantage of programs such as special discount offers. Preferably, the mailings of “specials” are controlled so that customers do not receive more than a predetermined number of specials in a given time period (e.g., 3-5 per week, including no more than one per day). Additional rules may also be used to prevent customers from receiving duplicate specials, or from receiving multiple specials from the same channel or category, during a given time period.

Specials are preferably targeted to particular users using their stored information. Each special has a predetermined target audience. The target audience may be determined solely by stored preferences for various topics (e.g., either small business within the business channel or home office within the decorating channel for a publication targeted at planning small offices), or may also include demographic information such as age and location.

Specials are sent on a regular basis (e.g., once a day). For a given batch of specials, it is first determined which customers fall within the target groups. Specials are ranked so that customers falling in more than one target group will receive only one special. In addition, one or more suppression rules may be applied. These may include enforcing daily and/or weekly maximums. In addition, specials may not be sent to people who already subscribe to the offered magazine or who have already seen the same special (although a lower-ranked special may be sent instead in these cases). Optionally, suppression rules may be overridden for certain specials.

Specials include an HTML webpage that presents the special offer, generally in the context of one or more creative components. The customer may elect to subscribe to the offer by pressing a button, and saved customer data may be used to complete the purchase. Data collected on which customers choose to subscribe to which offers can be used to adjust customer observed preferences and to refine the design and targeting of specials.

Other embodiments of the invention will be apparent to those skilled in the art from a consideration of the specification or practice of the invention disclosed herein. It is intended that the specification and examples be considered as exemplary only, with the true scope and spirit of the invention being indicated by the following claims.

What is claimed is:

1. An on-line server system that selects media information for a user according to the user's preferences, comprising:
a content subsystem, wherein said content subsystem collects, stores and updates media information;
a profile subsystem, wherein said profile subsystem creates a user profile; and
an administration subsystem, wherein said administration subsystem is adapted and constructed to match the user profile with media information from the content subsystem, and
said administration subsystem periodically generates an electronic newsletter.

2. A system according to claim 1, wherein said content subsystem comprises a content database, wherein said content database collects, stores and updates summaries of media information.

3. A system according to claim 1, wherein the server system maintains data communication between said administration subsystem, profile subsystem and content subsystem.

4. A system according to claim 1, wherein said administration subsystem selects media information according to the user's profile.

5. A system according to claim 1, wherein said profile subsystem collects profile information from the user.

6. A system according to claim 5, wherein said profile information comprises a member of the group consisting of a record of the user's past interactions with the server, a record of the user's current interaction with the server, preferences indicated by the user, and any combination of the above.

7. A system according to claim 5, wherein said profile subsystem updates the user's profile based upon the user's interaction with the server.

8. A system according to claim 5, wherein said profile subsystem creates a first user profile comprising preferences indicated by the user and a second user profile comprising a record of the user's past interactions with the server.

9. A system according to claim 1, wherein said media information comprises a member of the group consisting of books, magazines, magazine articles, trade journals, music and film videos, film, radio, music, periodicals, newspapers, sections of the above, and any combination of the above.

10. A system according to claim 1, wherein said electronic newsletter comprises a member of the group consisting of media information, summaries of media information, advertisements, photographs, videos, visual art objects, audio objects, color, and any combination of the above.

11. A system according to claim 10, wherein said administration subsystem selects a member of the group consisting of advertisements, photographs, videos, visual art objects, audio objects, color, and any combination of the above, to match with media information according to the user profile.

12. A system according to claim 1, wherein said electronic newsletter allows the user to purchase or subscribe to a source of the media information.

13. A system according to claim 1, wherein said electronic newsletter allows the user to forward a member of media information, the electronic newsletter, and any combination of the above to an Internet user.

14. A system according to claim 2, wherein said content subsystem associates the summary of media information with a numerical value.

15. A system according to claim 14, wherein the content subsystem associates a summary of media information with a first numerical score a function of a member of the group consisting of a source of the summary, a price of the source, a distribution of the source, and any combination of the above.

16. A system according to claim 15, wherein said administration subsystem generates the electronic newsletter by matching the user's profile with the first numerical score.

17. A system according to claim 15, wherein said administration subsystem generates a first message for a first plurality of users comprising a first special offer, wherein said special offer is generated by matching the users' profiles with the first numerical score.

18. A system according to claim 17, wherein said first message is posted to the users via email or via an Internet site.

19. A system according to claim 17, wherein said first message allows the user to accept the special offer by subscribing to a source of media information.

20. A system according to claim 17, wherein said administration subsystem generates a second message for a second plurality of users comprising a second special offer, wherein said second plurality of users does not include any members of the first plurality of users.

21. A system according to claim 15, wherein said profile subsystem associates the user profile with a second numerical score as a function of a member of the group consisting of:
(i) a number of times a summary is selected by the user;
(ii) a sequence in which the summary is selected or viewed with respect to other summaries provided to the user by the server;
(iii) a sequence in which the summary is selected or viewed with respect to other summaries provided to other users;
(iv) a number of media the user has purchased;
(v) a route in which the user obtained access to the server; and
(vi) any combination of the above.

22. A system according to claim 21, wherein said administration subsystem generates the electronic newsletter by matching the user's profile with a member of the first numerical score, the second numerical score, and any combination of the above.

23. A method of selecting content for a Website user, comprising:
(i) comparing a user profile with a content score for each of a plurality of content summaries;
(ii) identifying at least one content summary having a content score most closely correlated to the user profile, wherein the content summary comprises a freestanding idea representative of a source of the content; and
(iii) providing at least one content summary to the user in an electronic newsletter.

24. A method according to claim 23, further comprising compiling the user profile, wherein the user profile comprises a member of the group consisting of user information derived from observation of the user, information provided by the user, and any combination of the above.

25. A method according to claim 24; wherein said user information further comprises a member of the group consisting of a record of the user's past and current interaction with the server, preferences indicated by the user and any combination of the above.

26. A method according to claim 23, further comprising compiling the content score, wherein the content score comprises a function of a member of the group consisting of a topic of the content summary, an age of the summary, a price of the source, a sales volume of the source, the source of the content, a frequency with which content summaries from the source are used, a profitability of the source, and any combination of the above.

27. A method according to claim 23, further comprising providing a plurality of rules for performing the steps of comparing and identifying.

28. A method according to claim 23 wherein the step of providing summaries comprises providing an option for the user to perform an action selected from the group consisting of requesting an additional content summary, forwarding at least one of the content summaries to an Internet user, purchasing the content source, and any combination of the above.

29. A method according to claim 28, further comprising updating the user profile when the user requests an additional content summary.

30. The method of claim 23, further comprising presenting an additional element to the user, wherein the additional element comprises a member of the group consisting of an advertisement for the source of the content, a picture of the source of the content, a visual art object, an audio object, a color, and any combination of the above.

31. The method of claim 23, further comprising generating a first message for a plurality of users comprising a first special offer, wherein said special offer is generated by matching the users' profiles with the content score.

32. The method of claim 31 further comprising posting said first message to the users via email or via an Internet site.

33. The method of claim 31, wherein the first message allows the user to accept the special offer by subscribing to the source of the content.

34. The method of claim 31, further comprising generating a second message for a second plurality of users comprising a second special offer, wherein said second plurality of users does not include any members of the first plurality of users.
